(19) United States
(12) Patent Application Publication
(10) Pub. No.: US 2022/0227092 A1
(43) Pub. Date: Jul. 21, 2022

(54) BIRD PROTECTION GLASS

(71) Applicant: sedak GmbH & Co. KG, Gersthofen (DE)

(72) Inventor: Fritz SCHLÖGL, Stadtbergen (DE)

(73) Assignee: sedak GmbH & Co. KG, Gersthofen (DE)

(21) Appl. No.: 17/579,723

(22) Filed: Jan. 20, 2022

(30) Foreign Application Priority Data
Jan. 21, 2021 (DE) 10 2021 101 186.8

(51) Int. Cl. B32B 3/10; A01M 29/00; B32B 17/06

(52) U.S. Cl. CPC B32B 3/10; A01M 29/00; B32B 2419/00; B32B 2250/02; B32B 2307/416; B32B 17/06

(57) ABSTRACT

A bird protection glass includes a glass pane with a periodically repeating dot pattern, the reflection properties of which differ from those of the glass pane. In order to be effective, known bird protection glass had to be printed relatively densely, which compromised the visual appearance and transparency. The task of designing a bird protection glass so that it is highly effective, on the one hand, and only slightly compromises the transparent effect of the glass, on the other, is realized in that a maximum of 5% of the surface of glass pane is covered with the dot pattern.

### FIELD OF THE DISCLOSURE

The disclosure concerns bird protection glass. In particular, the dislcosure relates to a bird protection glass with a glass pane and a periodically repeating dot pattern, the reflection properties of which differ from those of the glass pane.

### BACKGROUND

Bird deaths from glass panes are today one of the most well-known problems in the area of bird protection. Many buildings could be built more bird-friendly if appropriate bird protection glass were used. Birds can usually easily fly around obstacles in their habitats, but are not prepared for invisible obstacles such as panes of glass. The risk of collision is extremely high. Various official entities expect at least one killed bird per year per building. Even when birds initially appear uninjured following an impact, every other one subsequently dies from internal injuries. Almost all bird groups are affected, including even rare and endangered species.

Glass is hazardous to birds in two respects. On the one hand, it is transparent and therefore invisible, on the other hand, it reflects the surroundings and the reflected trees and sky are imaged and simulate a habitat or flight zone.

Special bird protection glass is therefore used in many new buildings and even in the renovation of old buildings. For example, this involves ribbed, fluted, sandblasted, etched, frosted or printed glass with a coverage of usually at least 25% of the entire surface. Corresponding imprints can also be subsequently applied, for example, as adhesive films on glass panes. It has been shown that the silhouettes of raptors are usually not deterrent, since birds take heed not only of the silhouette but also to the pattern of movement, which a static silhouette does not have.

The Vienna Ombuds Office for Environmental Protection has specialized in methods for investigating bird strikes on glass surfaces and has conducted flight experiments in a so-called flight tunnel. The birds are sent through a 7.5-m long tunnel that is rotatably mounted and manually operated to follow the position of the sun, thereby always ensuring a symmetrical and largely uniform incidence of light on the test panes. The test tunnel enables investigations involving reflections. Two glass panes situated next to each other are found at the end of the tunnel, one unmarked and serving as a reference pane and the other coated or printed in order to test its properties as bird protection glass. The test birds are adapted to daylight from the outside and placed in a launch tube and begin immediately from the dark rear end toward the open front end of the tunnel. A net used to trap the birds is situated 10 cm in front of the end of the tunnel, which due to its limited thread thickness falls below the frontal visual acuity of the birds and is therefore not perceived. The birds are therefore gently intercepted. In this test, the number of birds that are deterred by the bird protection glass and fly toward the reference glass is evaluated. A 50:50 ratio would mean that the bird protection glass would have no effect, since just as many birds fly toward the bird protection glass as the reference glass. A proportion of birds that fly toward the bird protection glass between 10 and 20% indicates that the bird protection glass is (marginally) suitable and a proportion of birds below 10% shows it to be highly effective.

The previously tested bird protection glasses sometimes had highly effective properties, which, however, were always associated with a relatively dense printing on the bird protection glass. For example, bird protection glasses with a dot pattern with a coverage of 27% were found to be suitable. Some improvement was also made in exceptional cases with a white dot pattern on float glass and a coverage of 6.3%.

However, this has the drawback that the dot pattern not only attracts the attention of the birds, but also has a displeasing appearance to humans and imparts an undesirable overlay to a glass surface that is intended to be transparent. The same effects apply to incidence of light in a building and of course to the transparency of the glass.

DE 10 2011 103 132 A1 describes a pane element with a protective device against bird strikes, which is provided with a coating over the entire surface that absorbs light in the wavelength range between 320 nm and 420 nm and that emits light by means of the Stokes shift in the longer wavelength region and is therefore intended to be visible to a bird as an obstacle that cannot be flown through.

The object of DE 10 2013 104 212 A1 is a bird protection glass comprising a transparent substrate with a bird protection coating having at least one layer that contains at least one nitrite, where the precise alloy is further defined in the invention document. This also involves a full-surface coating of the glass.

CA 2 911 782 describes bird protection windows with at least one optical brightener that also extends over the entire surface of the bird protection glass.

US 2009/0047487 A1 relates to a method and device for preventing birds from striking glass and plastic surfaces by using a dot pattern or vertical or horizontal lines. This printing, however, is only visible to birds and reflects in a wavelength range between 300 and 400 nm. Bird protection glass of this type with printing that is invisible to humans also has very little effect on birds. The impact rate remains high.

### SUMMARY

The disclosure relates to a bird protection glass that it is highly effective, on the one hand, and only slightly compromises the transparent effect of the glass, on the other.

Advantageous refinements and embodiments are disclosed herein.

The inventor recognized that with the appropriate selection of patterning of the glass only a limited coverage area is sufficient to achieve the desired results. In particular, it is sufficient if less than 5% of the surface of the glass pane is covered with the dot pattern. It can already be sufficient that only a maximum of 2% of the surface is covered with the dot pattern or even less than 1% of the surface. In practice, this means that the dot pattern is still perceptible by humans and ensures normal incidence of light as well as good transparency and visibility.

The dot pattern can preferably consist of round or square dots and in a further preferred embodiment the spacing of adjacent dots is at least seven times the diameter or side length of each dot, preferably ten times the diameter or side length. The spacings are therefore relatively large in relation to the diameter and side length.

The dot pattern in a particularly advantageous and effective embodiment has a gloss level of at least 60%. In another preferred embodiment, the dot pattern contains metallic particles, for example, of silver or gold. The dot pattern can be applied to the glass pane by stoving or introduced into the glass pane by lamination.

It has been shown to be advantageous if the dot pattern is black or white.

### BRIEF DESCRIPTION OF THE DRAWINGS

Two embodiment examples of the invention are further described below with reference to the accompanying drawings. These show:

FIG. 1 a plan view of part of a glass pane for bird protection according to the invention with a dot pattern of squares;

FIG. 2 a glass pane according to FIG. 1 in which the dot pattern consists of round dots instead of squares.

### DETAILED DESCRIPTION

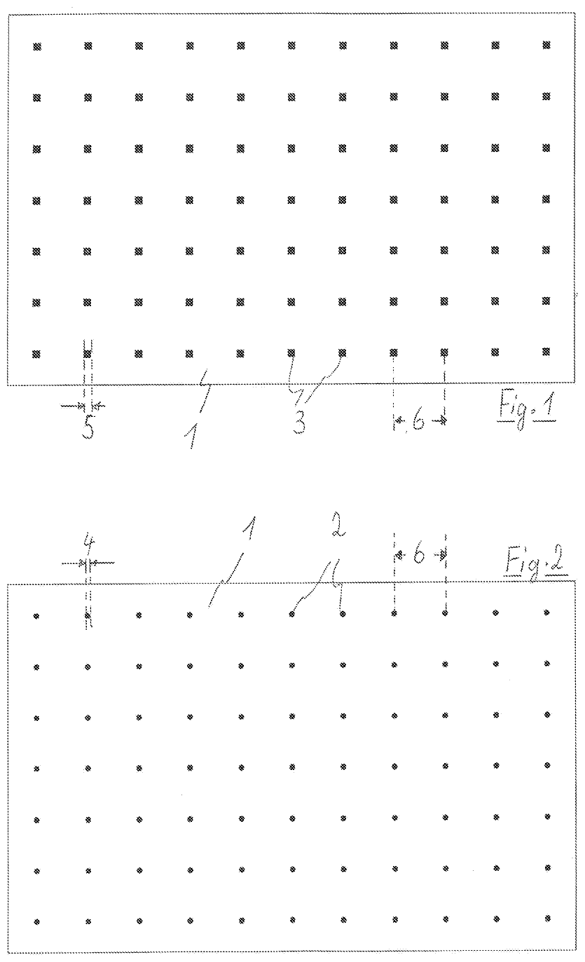

The glass pane 1 consists, for example, of float glass or another glass suitable for glazing of buildings in the glass pane 1 for bird protection glass depicted schematically in FIG. 1. This is a fully transparent glass, which—depending on the wishes of the client or architect—can also be tinted or coated. The glass pane 1 has a periodically repeating dot pattern and specifically a dot pattern consisting of small squares 3 in the depicted embodiment example. The squares are arranged with a double mirror symmetry so that rows and columns produce identical squares. The side length 5 of each square dot 3 is 12 mm, and the distance 6 between adjacent square dots 3 is 90 mm, measured center to center. This produces a degree of coverage of only 1.8%. This fraction of the glass pane 1 is therefore covered with the dot pattern of square dots 3. The distance 6 between adjacent dots, which is defined as the center-to-center distance 6 of adjacent dots 3 from each other, is over seven times the side length 5 of each square dot 3 in the depicted embodiment example.

In another embodiment, shown in FIG. 2, circular dots 2 are applied to the glass pane 1 instead of square dots 3. In this embodiment example, the surface of the glass pane 1 is doubly axially symmetrical in the same way, i.e., covered with round dots 2 arranged in rows and columns. The diameter of each round dot 2 is 9 mm and the center-to-center distance 6 is 90 mm. The distance 6 between adjacent dots 2 in this embodiment is therefore ten times the diameter 4 of each round dot 2. The total coverage in this embodiment example is only 0.8% of the surface of glass pane 1.

In both embodiment examples, both according to FIG. 1 and FIG. 2, the dot patterns have a gloss level of at least 60%. However, the gloss level can be higher or lower.

The dot pattern preferably but not necessarily has metallic particles, consisting of gold, silver or other metals.

The dot pattern in both embodiments can be applied to glass pane 1, for example, by baking, or introduced into glass pane 1 by laminating. The dots 3 or 2 can be implemented in a black color or a white color in advantageous embodiments both in the embodiments according to FIG. 1 and according to FIG. 2.

Experiments with the flight tunnel described in the introduction have shown that in the embodiment according to FIG. 1 (square dots 3) only 10% of the birds are directed toward the bird protection glass under test. This results in an efficiency of 90%.

In corresponding experiments with the bird protection glass according to FIG. 2 (round dots), only 14% of the tested birds flew toward the bird protection glass, which gives an efficiency of 86%.

It was therefore surprisingly shown that covering surfaces of well below 5%, in one case 1.8% and in the other case only 0.8%, are sufficient to achieve extremely satisfactory results in the test with the employed dot pattern.

1. A bird protection glass, having a glass pane with a periodically repeating dot pattern, whose reflection properties differ from reflection properties of the glass pane, a maximum of 5% of the surface of glass pane being covered with the dot pattern, wherein the dot pattern is implemented in black or white.

2. The bird protection glass according to claim 1, wherein a maximum of 2% of the surface of the glass pane is covered with the dot pattern.

3. The bird protection glass according to claim 2, wherein a maximum of 1% of the surface of the glass pane is covered with the dot pattern.

4. The bird protection glass according to claim 1, wherein the dot pattern consists of round dots.

5. The bird protection glass according to claim 1, wherein the dot pattern consists of square dots.

6. The bird protection glass according to claim 1, wherein a distance between adjacent dots, measured from center to center of the adjacent dots is at least seven times the diameter or side length of each dot.

7. The bird protection glass according to claim 6, wherein the distance between adjacent dots, measured from center to center of the adjacent dots, is at least 10 times the diameter or side length of each dot.

8. The bird protection glass according to claim 1, wherein the dot pattern has a gloss level of at least 60%.

9. The bird protection glass according to claim 1, wherein the dot pattern contains metallic particles.

10. The bird protection glass according to claim 1, wherein the dot pattern is applied to the glass panes by baking.

11. The bird protection glass according to the claim 1, wherein the dot pattern is introduced into the glass pane by lamination.
